(19) United States
(12) Patent Application Publication
(10) Pub. No.: US 2017/0190601 A1
(43) Pub. Date: Jul. 6, 2017

(54) OXIDATION AND COLLOIDAL DESTABILIZATION WASTE WATER TREATMENT

(71) Applicant: H2Oxidation, LLC, Austin, TX (US)

(72) Inventors: Mark Augustine, Austin, TX (US); David C. Burt, Austin, TX (US)

(21) Appl. No.: 15/316,410

(22) PCT Filed: Jun. 4, 2015
(86) PCT No.: PCT/US15/34254

§ 371 Date: Dec. 5, 2016

Related U.S. Application Data
(60) Provisional application No. 62/007,838, filed on Jun. 4, 2014.

(51) Int. Cl. C02F 1/78; C02F 1/52

(52) U.S. Cl. CPC C02F 1/78; C02F 1/5209; C02F 2209/005; C02F 2209/10; C02F 2209/06

(57) ABSTRACT

A method for treating waste water includes measuring oxidation-reduction potential (ORP) in at least one location in the waste water and measuring, in the waste water, one or more characteristics associated with particulate matter or organic material in the water. One or more values associated with treatment of the water is computed based on measurements of ORP and measurements of the characteristics associated with particulate matter or organic matter in the water. A level of ozonation in the waste water is adjusted based on the computed values.

### BACKGROUND

Field

The present invention relates to waste water treatment systems and methods. More particularly, the present invention relates to methods and systems of recycling industrial waste water to reuse quality.

Description of the Related Art

Various types of industrial waste water include high levels of contaminants, suspended matter, solids, organic matter, and other undesirable materials. Many existing treatment methods and systems improve the quality of the waste water, but not to a quality level sufficient to allow the treated water to be re-used. Moreover, some existing treatment methods rely on batch processing, which results in inefficiencies in the treatment process.

### SUMMARY

Systems and methods for treating waste water are described herein. In an embodiment, a method for treating waste water includes measuring oxidation-reduction potential (ORP) in at least one location in the waste water and measuring, in the waste water, one or more characteristics associated with particulate matter or organic material in the water. One or more values associated with treatment of the water are computed based on measurements of ORP and measurements of the characteristics associated with particulate matter or organic matter in the water. A level of ozonation in the waste water is adjusted based on the computed values.

In an embodiment, a water treatment system includes one or more pre-flocculation ozonation units, one or more flocculation units, and a controller. The pre-flocculation ozonation units is configured to treat waste water. The flocculation units mix a stream of waste water such that flocculation in the waste water is achieved. The controller controls oxidation based on measurements of ORP and measurements of characteristics associated with particulate matter or organic material in the waste water (for example, turbidity or total organic carbon).

In some embodiments, a waste water treatment system receives waste water that is not ready to be treated in publicly owned treatment works. The system treats the waste water such that the water is ready to be treated in publicly owned treatment works.

### BRIEF DESCRIPTION OF THE DRAWINGS

FIG. 1 is a diagram illustrating flow in a water treatment system that uses oxidation and colloidal destabilization.

FIG. 2 illustrates one embodiment of treating waste water based on ORP and other characteristics of the waste water.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF ILLUSTRATIVE EMBODIMENTS

In some embodiments, a system uses oxidation and colloidal destabilization to recycle industrial waste water to reuse quality. Synergistic technologies may be monitored and controlled by Oxidation Reduction and Potential, with checks and balances of pH, EC/TDS, DO, TOC and Turbidity automatically. In one embodiment, the system provides continuous flow flocculation. Continuous flow flocculation may be a more efficient implementation of colloidal technology than flocculation by way of a batch treatment. The treatments described herein may be guaranteed with very little overall maintenance and operation.

Waste water to be treated may be from any of various industrial uses, including manufacturing, hydrocarbon production, metal production, facilities, or construction. In certain embodiments, non-industrial water may be treated as described herein.

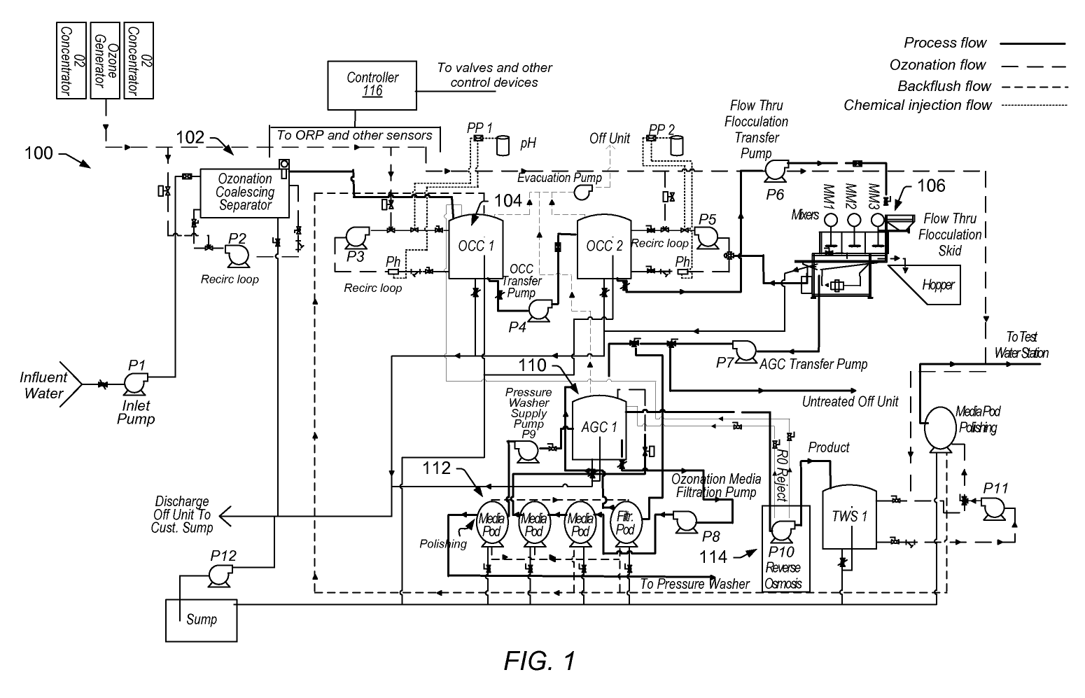

FIG. 1 is a diagram illustrating flow in a water treatment system that uses oxidation and colloidal destabilization. Water treatment system 100 includes ozonation coalescing separator 102, oxidation coagulation clarifiers 104, flow thru flocculation skid 106, agglomeration coagulation clarifier 110, multi-media filtration pods 112, reverse osmosis unit 114, and controller 116. Controller 116 may be coupled to various sensors and control devices, such as ORP sensors (in some cases, devices and sensors are omitted from FIG. 1 for clarity). Various elements of water treatment system are described below.

Ozonation Coalescing Separator

Water first may enter the unit into the Ozonation Coalescing Separator 102 for the coalescing, separation and collection of free oils. The process flow may be downward vertical from top to bottom with upward migration of Ozone opposite the flow. The coalescing compartment may include coalescing media (for example, 2 cubic foot in series of Polypropylene Coalescing Media per 10 gpm flow). The Ozonation Coalescing Separator may be used for separation and coalescing of free and purgeable molecular oils having a specific gravity less than water. Having the maximum amount of surface area for suspending the oil droplets, the droplets may attach to the polypropylene matrix media and coalesce to achieve a larger globule, lighter than water, which eventually breaks loose with upward migration through the media and floats up and to the top of the chamber.

Ozone may be venturi-injected and recirculated in a separate loop with upward vertical flow from the bottom to the top, opposite of the waste water flow, for maximum ozone saturation. The ozone may assist in the separation and coagulation of the dissolved oils for easier removal through coalescing. The ozone may also oxidize and eliminate bacteria in the waste water, while maintaining layering or bacterial growth on the surface area of the filter media to insure ongoing and consistent efficiency.

Oxidation Reduction and Potential (“ORP”) may be monitored on the inlet of the ozonation loop to insure reduction or potential targets are met. In various embodiments, EC/TDS, Total Dissolved Solids, and pH are monitored as initial benchmarks for the downstream treatment.

The top of the separator compartment may include a belt oil skimmer for oil removal and collection of coalesced and free floating oils. The belt skimmer is sized for anticipated oil removal and total flow rate.

Ozonation

Some or all of the ozonation recirculation loops, beginning with the O3CS, may be supplied with individual ozone units. Totals may be 1.5 gr/hr per gpm waste water flow per clarifier and up to 3 gr/hr per gpm waste water flow per clarifier in the Pre-treatment Oxidation Clarifiers, PTOC. The ozone generators may be variable drive output. The ozone generators may be controlled with a PLC to target certain points of treatment. If there is not enough, the drive may speed up, whereas if there is too much, the drive may slow down. Oxygen may be concentrated to 90% with molecular sieve separation oxygen concentrators. The molecular sieve separation oxygen concentrators operate through a series of cycles of filtration and purging. Air inside the concentrator may be pressurized through a set of chemical filters (for example, a molecular sieve.) This filter is made up of silicate granules (for example, Zeolite) which sieve the nitrogen out of the air, concentrating the oxygen. Through this process, the system may produce oxygen of up to 90% concentration. This concentrated oxygen may be supplied to corona discharge ozone generators to achieve 6.5% ozone. In the corona discharge, current flows from an electrode with a high potential into a neutral field and by ionizing that field creates a region of energy capable of breaking down Oxygen and creating Trioxygen or Ozone, O3.

Ozone may be individually venturi injected in each loop for maximum saturation in the waste water. The venturi may be a differential pressure injector with internal mixing vanes. When pressured flow is introduced into the inlet, a larger diameter, to the venturi, a pressure differential may be created at the outlet, a smaller diameter, and a vacuum created inside the venturi body. An inlet in the venturi body is the injection site for ozone which is pulled in from the vacuum which creates a laminar velocity shear and saturates the ozone gas into the flow. Venturi injection may be more efficient than diffusion only (for example, 99.5% efficient versus 29.7%).

Ozone has many purposes throughout the treatment in the unit. The ozone eliminates the organic loading from start to finish in the treatment process. The ozone may also a predominant stair step treatment of the treatment process.

At some or all of the injection points during the pre-treatment and post-treatment, ozone may be monitored by way of ORP to achieved planned treatment strategy for the waste water targeted. ORP monitoring may be used to insure treatment of the water for each phase. In one embodiment, ORP monitoring is used to insure treatment of water coalescing and oxidation in the O3CS, coagulation and solvation in the PTOC, and agglomeration in the Agglomeration Oxidation Clarifier, AOC.

Oxidation Reduction and Potential

The inlet of each recirculation loop in the unit may be monitored and the ozone dosage amount is controlled with the ongoing levels of ORP gathered and input into the PLC. In the waste water, the reduction potential is a measure of the tendency of the solution to either gain or lose electrons when it is subject to change. In various embodiments, ozone (oxygen having an electronegative value of 3.44 on the Pauling Scale) is used for reduction and potential catalyst. The unit may be set to maintain pre-determined levels of Reduction or Potential and automatically control ozonation injection amounts to achieve required treatment per phase loop. Separate phases of ozonation treatment may be directly monitored to insure all treatment levels are maintained in the three phase areas of treatment.

From the centrifugal separation unit, the waste water stream passes through a flow conduit to a mix tank for an ozonation pre-treatment process and a subsequent flocculation process. The preferred ozonation pre-treatment is carried out in a first zone of the mixing tank made up of one elongated chamber with oil separation and skimming capabilities. At two points in the chamber, waste water is recirculated through a venturi with the injection of ozone. Ozone injection pumps create the venturi effect, pulling out liquid and then re-injecting ozonated water, typically at a rate on the order of 120 gallons per minute. The initial ozone injection processes carried out in the first half of the chamber is for the separation and accumulation of free oils for belt skim removal and BOD reduction. The second ozone injection processes carried out in the second half of the chamber is for the coagulation of contaminants in the waste water for efficient flocculation removal in a subsequent flocculation step. The ozonation processes can be monitored and regulated through an automatic control system.

Pre-Treatment Oxidation Clarifiers

Treatment may be continued with a high saturation of ozonation achieved in the PTOC (for example, 3 gr/hr per gpm waste water flow) in each clarifier to balance the efficiency and success of the flocculation process in the Flow Thru Flocculation Skid, FTFS. In some embodiments, solvation is specifically target in this pre-treatment process. Solvation is the process of attraction and association of molecules of a solvent with molecules or ions of a solute. The process may include two or more clarifiers in series. The total volume may be, in one example, 15 gallons per 1 gpm waste water flow, each with individual ozonation recirculation loops. The individual volume and number of clarifiers may be selected based on waste water category and contaminants. Also on the inlet of these loops, along with the ORP monitor, a pH monitor may be included to control pH for adjustments in any or all of the three separate areas in the treatment process. The pH may be adjusted automatically for the treatment process in either the PTOC or in any of the mix chambers of the FTFS. Monitoring of the ORP on the inlet of the clarifier ozonation loops may be used to insure reduction or potential targets are met per clarifier. In one embodiment, a reduction is monitored and treated with heavy saturations of ozone in the initial clarifiers, while an oxidation potential is targeted for the final PTOC for efficiency and success of the flocculation treatment.

Hydrators and Augers

Sodium bentonite, polymers and other additives may be added to the treatment process is either dry or hydrated form, or even a combination of both. Hydrators may include auger assemblies, which may feed a multi chamber, multi mixer continuous flow unit much as in the FTFS. The continuous flow unit may mix on demand with recycled water to a pre-set concentration and/or mole strength determined of the dry blends. The hydrators may deliver the liquid directly to the determined mix chamber. The dry blends may also be added in dry form, non-hydrated, at the first mix chamber of the FTFS by way of auger assemblies delivering a metered amount per sequence of time or volume as the hydrates. Generally, the heavier the solid content of the waste water, the relatively greater the need of the hydrated additives versus dry.

Flocculation is achieved in three continuous flow mix chambers located in the mixing tank. The first flocculation chamber may be where the majority of the water pre-treatment chemicals and flocculent are added. The initial hydration and mix of the flocculent is added in this chamber to begin the flocculation process of colloidal treatment. The colloidal treatment may be accomplished with polymerized bentonite clay blends or combinations with hydrated polymer concentrates and pH adjustment chemicals.

The second flocculation chamber may be for the continuation of the flocculent mix process. It is adjusted from slow fold to high speed mixing, depending on the loading of the waste water and nature of the treatment chemicals being added, which will only be liquid chemicals in the second chamber.

The third flocculation chamber may be for the final process of the continuous flow hydration and mixing. The mix settings on the third chamber may achieve final agglomeration of the flocculent for post-treatment filtration. Liquid treatment is possible in the third chamber as a final step of flocculent binding consistency.

Flow Thru Flocculation Skid

Pretreated water may enter the FTFS unit for polymer colloidal attraction, separation and encapsulation of all contaminants. A large variety of polymers may be used with varieties targeting mole strength, charges and chain makeup. Other components may be added as a binder. Sodium Bentonite may be added as an encapsulant. Bentonite is clay consisting of mostly Montmorillonite. It is capable of absorbing and holding several times its dry mass in weight. If waste water being treated has a makeup of Sodium Bentonite in the water, it may be possible to use the existing clay without the addition of more.

The mix chambers are in series with cascading flow from one mix chamber to the next. The total combined volume may be sized to, in one example, 15 gallons per 1 gpm waste water flow. Each mix chamber may include a dedicated mixer which has control capability of mix speed and rotation direction. The hydrates or dry blends may be added on a diagnosed basis. In certain embodiments, a computer system makes adjustments from ORP, turbidity or EC/TDS readings that can re-set treatment loadings for a separates waste water makeup entering the treatment unit.

After continuous flow mixing in the mix tank, flocculent filtration may be carried out, in this example, by way of centrifugal mechanical separation in drum (cylinder) filter. The drum filter may include filter mesh located in a rotary chamber. The water ay enter a revolving mesh lined cylinder allowing the filtered water through with the filtrate exiting the opposite end of the cylinder for collection and disposal. The filtered water may be collected in the base of the unit for automatic pump off to the next treatment step.

Drum Filter

On a volume overflow from the final mix chamber, clear recycled water and flocculated solids may spill into the Drum Filter, DF, for separation and collection. The dewatering screen size and rotation speed of the drum may be specific to the solid loading and amount of clay used in the treatment process. Solids may move through the drum filter rolling between a flighting shoulder moving in a screwing motion to the end of the drum as water drains through the outer screen layer of the drum into a collection and transfer tank below. A spray bar may mist the drum through the rotation from the outside in to maintain surface opening in the screens and lubricate the screen for the solids to roll. The water collected from the drum may be pumped on to the Agglomeration Oxidation Clarifier (“AGC”) for further treatment. A portion of that water may be reused in the spray bar assembly. The solids leaving the drum filter are ready for final dewatering.

Vacuum Dewatering Table

Sludge leaving the drum filter may be deposited onto a moving filter table for final dewatering. After entering the table, the solids may be evenly distributed across the table surface creating a cake. At numerous points in the table, a vacuum pulls water from the cake to remove the remaining water accessible from suction. The vacuum may be controlled by variable drive. The table is designed for minimum drag so to achieved maximum suction at all points.

The reservoir may serve as an inlet and mix point for additional post-treatment chemical addition for the treated water through automatic adjustment. For example, chemicals might be added for pH adjustment in the reservoir tank.

The waste water from the flocculent filtration step passes to a post-treatment ozonation step to assist in additional coagulation of post-treatment solids (which may be too small to be filtered by the cylinder filter).

Agglomeration Oxidation Clarifier

The Agglomeration Oxidation Clarifier 110 (“AGC”) may carry out a post flocculation ozonation treatment to break out and agglomerate, join together, any suspended solids, dissolved polymers or even residual emulsified compounds which may still be in suspension or colloidal, chemically bonded or emulsified in the water. In the example, this phase is a final phase of ozonation treatment. The treatment may be is volumetrically sized to 15 gallons per 1 gpm waste water flow.

As in previous ozonation recirculation loops, the ORP may be monitored for critical post treatment diagnosis. pH may be monitored for potential post treatment adjustments necessary for continuing polishing of the recycled water. The monitoring should show an increase in potential in each compartment with a final goal in the vicinity of 400 mV. Dissolved Ozone, DO, is also monitored in each recirculation loop to correlate measurements between ORP and DO. Each recirculation loop is supplied with individual ozone systems totaling 1.5 gr/hr per gpm waste water flow per clarifier compartment. With the flow in series on numerous compartments in the AGC, clarifier compartments are separated with progressing smaller size porosity mesh for agglomerated solids separation and collection. The number of clarifier compartments and volume of each is dependent on waste water category and contaminants. Water from the final compartment of the AGC is monitored for Turbidity, EC/TDS and Total Organic Carbon.

The waste water is then post filtered in a media filtration tank capable of collection, filtration, and back flushing of post-treatment residual and coagulated solids. The vessel may be a carbon pod filter unit containing various treatment media such as activated charcoal, clays or other post-treatment media.

Multi Media Filtration Pod

Water leaving the filter AGC may pass through a series of back flushable, Multi Media Filtration Pods 112, MMFP, for any residual suspended solids which may have been too small for the AGC mesh sizes. The media may also trap and encapsulate targeted contaminants expected in the water that colloidal treatment may not completely remove. The media pod may be automatically back flushed on pressure demand. The media filters may be a combination on mechanical and chemical filtration with targets being suspended solids, dissolved polymers or even residual emulsified compounds which may have been sloughed off in the filtration process. Examples of media materials that may be used include activated alumina, activated carbon and Zeolite. The media materials may be selected to target residual waste from distinct waste streams. For example, activated alumina is manufactured from aluminum hydroxide and a gram can have a surface area of over 200 square meters. It has a unique tunnel like porosity which can target metals and specific contaminants. Activated Carbon is carbon produced from a carbonaceous source material such as nutshells, coconut husk, peat, wood, lignite, coal and petroleum pitch. Activated carbon can be physically or chemically activated and a gram of activated carbon can have a surface area in access of 1500 square meters. Zeolite is a microporous, mineral that can accommodate a wide variety of cations, such as sodium, potassium, calcium, magnesium and others. A Zeolite media may selectively sort molecules based primarily on a size exclusion process.

Post-treatment mechanical filtration by means of one or more bag filtration units may be used to ensure a predetermined minimum filtration discharge range in microns of treated water. Post-treatment mechanical filtration may be on the order of 100 microns or less.

Polishing

In some embodiments, water from the AGC goes through final polishing and ozone destruction. In one embodiment, polishing includes 1 micron mechanical filtration to remove any residual solids which may have come from the MMFP. After passage through the filters, water may pass through Ultraviolet Light, UV, for ozone destruction of any residual ozone which may still be in saturation in the water. Optional chloride reduction with membrane technologies may be utilized for additional post-treatment as well as filtrate solidification.

Reverse Osmosis

At this point the water is now of quality to go to Reverse Osmosis module 114 (“RO”) for final treatment without concern of pre-mature blinding of the membrane filters. RO filtration technology utilizes pressure to move a solution through a semipermeable membrane, permeate, and concentrating a solute on the pressure side of the membrane, reject. Final treatment with the RO may include the removal of TDS including salts and hardness minerals. Multiple stages in two to three separated phases of treatment may be used concentrate the solids as heavy as possible with membrane technology to achieve a maximum product water volume.

Treated Water

Two types of water are produced from the reverse osmosis. The first type is the reject which is clean bacteria free water with the concentrated minerals and salts from the treated water. The second type is product water, which may be of pristine quality and very low TDS.

Encapsulated Contaminants

Contaminants are encapsulated in sodium bentonite clay. The contaminants may pass Paint Filter Testing for moisture and Toxicity Characteristic Leaching Process Testing for land fill acceptance, depending on the initial waste water type and origin.

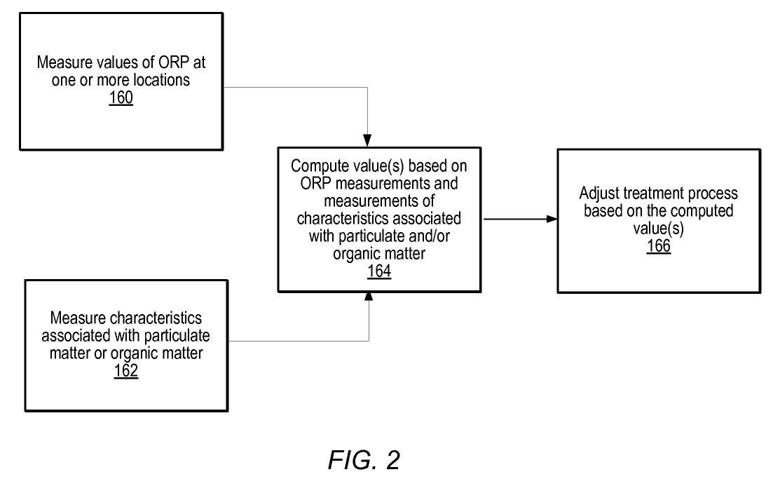

In some embodiments, a method of treating waste water includes controlling ozonation based on ORP and characteristic(s) of particulate matter/organic matter. FIG. 2 illustrates one embodiment of treating waste water based on ORP and other characteristics of the water. At 160, oxidation-reduction potential (ORP) may be measured in at least one location in the waste water. At 162, one or more characteristics associated with particulate matter or organic matter in the water are measured. At 164, one or more values associated with treatment of the water may be computed (for example, by programmable logic controller) based on at least one measurement of ORP and measurement of the characteristics associated with particulate matter or organic matter in the water. At 166, one or more adjustments may be made to control treatment processes based the computed value(s). In one embodiment, a level of ozonation in the waste water is adjusted based on the computed values. In certain embodiments, turbidity is measured and used for controlling ozonation. In certain embodiments, TOC is measured and used in controlling ozonation.

In some embodiments, waste water that is not ready to be treated in publicly owned treatment works is received into a system. The waste water is treated such that it is ready to be treated in publicly owned treatment works. In some embodiments, waste water from an industrial use is treated to allow the waste water to be treated by way of reverse osmosis.

In various embodiments, a water treatment system includes one or more water treatment control devices. A water treatment control device may include one or more computing devices and other components that control water treatment and sense characteristics of water that has been or is to be treated. In certain embodiments, as water treatment control device includes a controller, such as controller 116 described above relative to FIG. 1.

In some embodiments, a water treatment system includes a controller that uses measurement of ORP and other organic/or suspended/particulate characteristics. The water treatment system may include one or more pre-flocculation ozonation units, one or more flocculation units, and a controller. The flocculation units may mix at least a portion of the stream of waste water such that flocculation of the waste water is achieved. The controller controls oxidation in the waste water based on one or more measurements of ORP and measurements of one or more characteristics associated with particulate matter or organic material in the waste water.

In various embodiments, methods described herein may be implemented using a programmable logic controller (“PLC”). A PLC may be controlled using one or more computer systems. Computer systems may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

In various embodiments described herein, methods and systems used ORP measurements in combination with measurements of other characteristics of the waste water to control a treatment process. Systems and methods may nevertheless in certain embodiments include treatment systems and methods that do not include taking ORP measurements, or rely on such measurements to control a waste water treatment process.

In various embodiments described herein, methods and systems are used for waste water treatment. Systems and methods may nevertheless in certain embodiments be used for treatment of water that is not waste water, or for treatment of liquids or other than water.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

What is claimed is:

1. A method for treating waste water, comprising:
measuring oxidation-reduction potential (ORP) in at least one location in the waste water;
measuring, in the waste water, one or more characteristics associated with particulate matter or organic material in the water;
computing one or more values associated with treatment of the water based on at least one measurement of ORP and at least one measurement of at least one of the characteristics associated with particulate matter or organic matter in the water; and
adjusting a level of ozonation in the waste water based on at least one of the at least one of the computed values.

2. The method of claim 1, wherein at least one of the characteristics associated with particulate matter or organic matter in the water comprises a measure of turbidity.

3. The method of claim 1, wherein at least one of the characteristics associated with particulate matter or organic matter in the water comprises a measure of total organic carbon.

4. The method of claim 1, wherein at least one of the characteristics associated with particulate matter or organic matter in the water comprises a measure of conductivity or total dissolved solids.

5. The method of claim 1, further comprising measuring pH in at least one location in the waste water, computing at least one of the values is based at least in part on at least one measured value of pH of the waste water.

6. The method of claim 1, further comprising measuring dissolved ozone in at least one location in the waste water, wherein computing at least one of the values is based at least in part on the measured value of dissolved ozone.

7. The method of claim 1, further comprising:
measuring dissolved ozone in at least one location in the waste water; and
determining at least one correlation between measurements of ORP and measurements of dissolved ozone.

8. The method of claim 1, wherein ORP is measured in at least two locations in the waste water.

9. The method of claim 1, wherein ORP is measured at the inlet of a pre-treatment oxidation clarifier.

10. The method of claim 1, further comprising treating waste water by reverse osmosis.

11. The method of claim 1, further comprising receiving waste water that is not ready to be treated in publicly owned treatment works; and treating the waste water such that it is ready to be treated in publicly owned treatment works.

12. The method of claim 1, further comprising injecting ozone into the water such that at least a portion of the contaminants in the waste water coagulate.

13. The method of claim 1, further comprising mixing at least a portion of the stream such that flocculation is achieved in at least a portion of the waste water.

14. The method of claim 1, further comprising passing at least a portion of the waste water through a filter so as to separate at least a portion of the flocculated solids from the waste water.

15. The method of claim 1, further comprising injecting ozone into the waste water after flocculation.

16. The method of claim 1, further comprising treating at least part of the waste water by agglomerating suspended solids, dissolved polymers or residual emulsified compounds in the water.

17. A system for treating waste water, comprising:
one or more sensors configured to sense characteristics of the waste water; and
one or more water treatment control devices implemented on one or more computing devices,
wherein at least one of the one or more sensors is configured to implement:
measuring oxidation-reduction potential (ORP) in at least one location in the waste water; and
measuring, in the waste water, one or more characteristics associated with particulate matter or organic material in the water;
wherein at least one of the waste water treatment control devices is configured to implement:
computing one or more values associated with treatment of the water based on at least one measurement of ORP and at least one measurement of at least one of the characteristics associated with particulate matter or organic matter in the water; and
adjusting a level of ozonation in the waste water based on at least one of the at least one of the computed values.

18. A non-transitory, computer-readable storage medium comprising program instructions stored thereon, wherein the program instructions are configured to implement:
measuring oxidation-reduction potential (ORP) in at least one location in the waste water;
measuring, in the waste water, one or more characteristics associated with particulate matter or organic material in the water;
computing one or more values associated with treatment of the water based on at least one measurement of ORP and at least one measurement of at least one of the characteristics associated with particulate matter or organic matter in the water; and
adjusting a level of ozonation in the waste water based on at least one of the at least one of the computed values.

19. A water treatment system, comprising:
one or more pre-flocculation ozonation units, wherein at least one of the pre-flocculation ozonation units is configured to treat waste water;
one or more flocculation units, wherein at least one of the flocculation units is configured to mix at least a portion of the stream of waste water such that flocculation of at least a portion of the waste water is achieved; and
one or more controllers, wherein at least one of the controllers is configured to control oxidation based at least in part on one or more measurements of ORP in at least one location in the waste water and measurements of one or more characteristics associated with particulate matter or organic material in the waste water.

20. The method of claim 19, further comprising receiving waste water that is not ready to be treated in publicly owned treatment works; and treating the waste water such that it is ready to be treated in publicly owned treatment works.

21. The method of claim 19, wherein at least one of the flocculation units is configured for continuous flow of a waste water stream.

22. The method of claim 19, further comprising one or more agglomeration oxidation clarifiers.

23. The method of claim 19, further comprising one or more drum filters.

24. The method of claim 19, further comprising one or more multi-media filtration pods.

25. The method of claim 19, further comprising one or more polishing units.

26. The method of claim 19, further comprising hydrators.

27. A system for treating water, comprising:
one or more sensors configured to sense characteristics of the water; and
one or more water treatment control devices implemented on one or more computing devices,
wherein at least one of the one or more sensors is configured to implement:
measuring oxidation-reduction potential (ORP) in at least one location in the water;
wherein at least one of the water treatment control devices is configured to implement:
computing one or more values associated with treatment of the water based on at least one measurement of ORP and at least one other characteristic of the water; and
adjusting a characteristic of the water based at least in part on the measurement of ORP and the at least one other characteristics of the water.
